(19) United States
(12) Patent Application Publication
(10) Pub. No.: US 2025/0167969 A1
(43) Pub. Date: May 22, 2025

(54) APPARATUS AND METHOD FOR SUPPORTING COMMUNICATION BY USING MULTIPLE LAYERS IN WIRELESS LOCAL AREA NETWORK SYSTEM

(71) Applicant: SAMSUNG ELECTRONICS CO., LTD., Suwon-si (KR)

(72) Inventors: Myeongjin KIM, Suwon-si (KR); Jinmin Kim, Suwon-si (KR); Eunsung Jeon, Suwon-si (KR); Chulho Chung, Suwon-si (KR)

(73) Assignee: SAMSUNG ELECTRONICS CO., LTD., Suwon-si (KR)

(21) Appl. No.: 18/955,205

(22) Filed: Nov. 21, 2024

(30) Foreign Application Priority Data
Nov. 22, 2023 (KR) 10-2023-0163701

(51) Int. Cl. H04L 5/00; H04W 84/12

(52) U.S. Cl. CPC H04L 5/0094; H04W 84/12

(57) ABSTRACT

A wireless communication method of an apparatus includes determining a multi-layer transmission mode of transmitting data to a single user, based on modulation and coding schemes (MCSs) of each of a plurality of subchannels configuring a bandwidth channel, generating a first field indicating that the wireless communication method is based on the multi-layer transmission mode, generating a second field indicating a distribution of the plurality of subchannels and the MCSs, generating a physical protocol data unit (PPDU) including the first field and the second field, and transmitting the PPDU to an external device.

### CROSS-REFERENCE TO RELATED APPLICATIONS

This application claims benefit of priority under 35 U.S.C. § 119 to Korean Patent Application No. 10-2023-0163701, filed on Nov. 22, 2023, in the Korean Intellectual Property Office, the disclosure of which is incorporated by reference herein in its entirety.

### BACKGROUND

### 1. Field

The present disclosure relates to wireless communication, and more particularly, to an apparatus and method for supporting communication by using multiple layers in a wireless local area network (WLAN) system.

### 2. Description of Related Art

As an example of wireless communication, a WLAN is technology of connecting two or more devices to each other by using a wireless signal transmission method. For example, WLAN technology may be based on the Institute of Electrical and Electronics Engineers (IEEE) 802.11 standard. The IEEE 802.11 standard has evolved into various versions including 802.11b, 802.11a, 802.11g, 802.11n, 802.11ac, and 802.11ax, and may support a transmission speed of up to one (1) gigabyte per second (Gb/s) based on orthogonal frequency-division multiplexing (OFDM) technology.

In 802.11ac, data may be simultaneously transmitted to a plurality of users through a multi-user multi-input multi-output (MU-MIMO) technique. In 802.11ax, also referred to as high efficiency (HE), multiple accesses are realized by dividing and providing available subcarriers to users by applying MU-MIMO and orthogonal frequency-division multiple access (OFDMA) technology. Accordingly, a WLAN system to which 802.11ax has been applied may effectively support communication in dense areas and/or outdoor areas.

In 802.11be, also referred to as extremely high throughput (EHT), support for a six (6) GHz unlicensed frequency band, various bandwidths per channel, hybrid automatic repeat and request (HARQ) introduction, and up to 16×16 MIMO support may be realized. Accordingly, a next-general WLAN system may effectively support low latency and ultra-high speed transmission similarly to 5th generation (5G) cellular communication technology, such as, but not limited to new radio (NR). In ultra-high reliability (UHR), which may refer to a next generation of EHT, technology of supporting a bandwidth of up to 640 MHz per channel has been newly proposed in 802.11be, so as to increase spectral efficiency and data rate.

### SUMMARY

One or more example embodiments of the present disclosure provide an apparatus and method for providing communication by using multiple layers to a single user in a wireless local area network (WLAN) system.

According to an aspect of the present disclosure, a wireless communication method of an apparatus includes determining a multi-layer transmission mode of transmitting data to a single user, based on modulation and coding schemes (MCSs) different for each of a plurality of subchannels configuring a bandwidth channel, generating a first field indicating that the wireless communication method is based on the multi-layer transmission mode, generating a second field indicating a distribution of the plurality of subchannels and the MCSs, generating a physical protocol data unit (PPDU) including the first field and the second field, and transmitting the PPDU to an external device.

According to an aspect of the present disclosure, a wireless communication method of an apparatus includes receiving a PPDU from an external device, identifying that the PPDU is transmitted according to a multi-layer transmission mode, based on a first field of the PPDU, wherein the multi-layer transmission mode corresponds to a mode of transmitting data to a single user, based on MCSs of each of a plurality of subchannels, identifying a distribution of the plurality of subchannels within a bandwidth and the MCSs of each of the plurality of subchannels, based on a second field of the PPDU, and decoding the PPDU, based on the distribution of the plurality of subchannels and the MCSs of each of the plurality of subchannels.

According to an aspect of the present disclosure, a wireless communication method of an apparatus includes determining, based on a first MCS of a first subchannel from among a plurality of subchannels configuring a bandwidth channel and based on a second MCS of a second subchannel of the plurality of subchannels, a multi-layer transmission mode of transmitting data to a single user, the second MCS being different from the first MCS, the second subchannel being different from the first subchannel, generating a first field indicating that the wireless communication method is based on the multi-layer transmission mode, generating a second field indicating first RU information of the first subchannel, second RU information of the second subchannel, the first MCS, and the second MCS, generating a PPDU including the first field and the second field, and transmitting the PPDU to an external device.

According to an aspect of the present disclosure, a wireless communication method of an apparatus includes receiving a PPDU from an external device, identifying that the PPDU is transmitted according to a multi-layer transmission mode, based on a first field of the PPDU, wherein the multi-layer transmission mode corresponds to a mode of transmitting data to a single user, based on a MCS of a first subchannel from among a plurality of subchannels configuring a bandwidth channel and based on a second MCS of a second subchannel of the plurality of subchannels, the second MCS being different from the first MCS, the second subchannel being different from the first subchannel, identifying, based on a second field of the PPDU, a distribution of the first subchannel and the second subchannel in a bandwidth, the first MCS, and the second MCS, and decoding the PPDU, based on the distribution of the first subchannel and the second subchannel, the first MCS, and the second MCS.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram of a wireless communication system, according to an embodiment;

FIG. 2 is a block diagram of an apparatus, according to an embodiment;

FIG. 3 is a flowchart of an operating method of a wireless communication system, according to an embodiment;

FIG. 4 illustrates an example of frequency-wise modulation and coding scheme (MCS), according to an embodiment;

FIG. 5 is a diagram showing a physical protocol data unit (PPDU), according to an embodiment;

FIG. 6A illustrates an example of a universal signal (U-SIG) indicating a multi-layer transmission mode, according to an embodiment;

FIG. 6B illustrates an example of a table indicating a multi-layer transmission mode, according to an embodiment;

FIG. 7A illustrates an example of an ultra-high reliability-signal (UHR-SIG), according to an embodiment;

FIG. 7B illustrates an example of a resource unit (RU) allocation subfield table, according to an embodiment;

FIG. 7C illustrates an example of RU distribution in a frequency domain, according to an embodiment;

FIG. 7D illustrates an example of RU-wise MCS index, according to an embodiment;

FIG. 8A illustrates an example of a case where there are two UHR-SIG content channels, according to an embodiment;

FIG. 8B illustrates an example of a case where there is one UHR-SIG content channel, according to an embodiment;

FIG. 8C illustrates an example of an encoding unit of a UHR-SIG content channel, according to an embodiment;

FIG. 9 illustrates an example of an RU assignment subfield, according to an embodiment;

FIG. 10A illustrates an example of a UHR-SIG content channel including an RU assignment subfield, according to an embodiment;

FIG. 10B illustrates another example of a UHR-SIG content channel including an RU assignment subfield, according to an embodiment; and

FIG. 11 is a diagram of examples of an apparatus for wireless communication, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

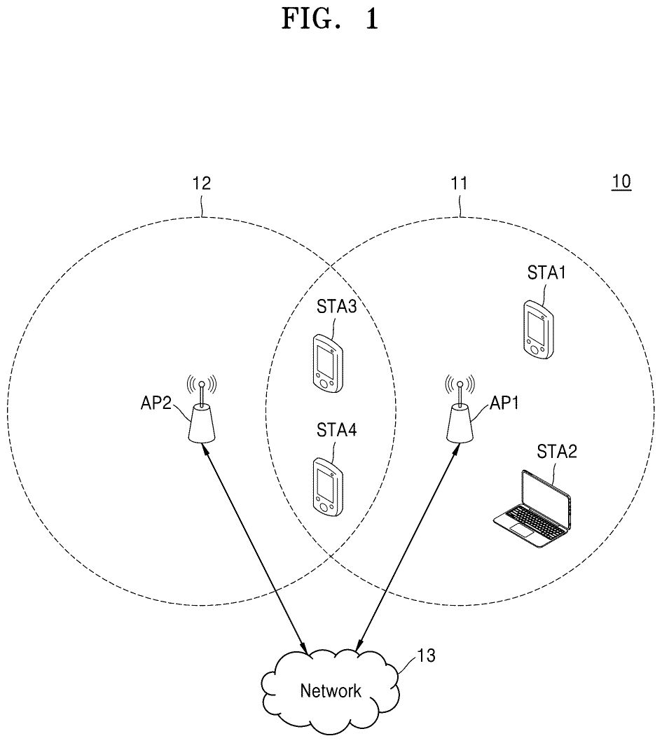

FIG. 1 is a diagram of a wireless communication system 10, according to an embodiment.

According to an embodiment, the wireless communication system 10 may correspond to a wireless local area network (WLAN) system. While describing embodiments in detail, a main target may be an orthogonal frequency-division multiplexing (OFDM) or orthogonal frequency-division multiple access (OFDMA)-based wireless communication system, in particular, the Institute Of Electrical And Electronics Engineers (IEEE) 802.11 standard. However, the present disclosure may be applicable to other communication systems (e.g., cellular communication systems such as, but not limited to, long-term evolution (LTE), LTE-advanced (LTE-A), new radio (NR), wireless broadband (WiBro), global system for mobile communication (GSM), and short-range communication systems such as, but not limited to, Bluetooth™ and near field communication (NFC) having similar technical background and channel types, without significantly departing from the scope of the present disclosure, and such applicability may be determined by one of ordinary skill in the art.

Various functions described below may be implemented and/or supported by artificial intelligence technology and/or one or more computer programs, and each computer program may be configured with computer-readable program code and executed by a computer-readable medium. The terms “application” and “program” may refer to one or more computer programs, software components, instruction sets, procedures, functions, objects, classes, instances, associated data, or some thereof suitable for implementation of suitable computer-readable program code. The term computer-readable program code may refer to any type of computer code including source code, object code, and execution code. The term computer-readable medium may refer to any type of medium that may be accessed by a computer, such as, but not limited to, read-only memory (ROM), random access memory (RAM), a hard disk drive, a compact disk (CD), a digital video disk (DVD), or any other type of memory. A non-transitory computer-readable medium may exclude wired, wireless, optical, or other communication links that transmit transient electricity or other signals. A non-transitory computer-readable medium may be and/or may include a medium on which data may be permanently stored or a medium on which data may be stored and overwritten later, such as, but not limited to, a rewritable optical disk, an erasable memory device, or the like.

In some embodiments, a hardware approach may be described as an example. However, embodiments may include technology using both hardware and software. That is, embodiments may not exclude a software-based approach.

As used herein, terms referring to control information, terms referring to an entry, terms referring to network entities, terms referring to messages, and/or terms referring to components of an apparatus may be exemplified for convenience of description. Thus, the present disclosure is not limited by terms described below, and other terms having the same technical meanings may be used.

Referring to FIG. 1, the wireless communication system 10 may include a first access point AP1, a second access point AP2, a first station STA1, a second station STA2, a third station STA3, and a fourth station STA4. The first access point AP1 and the second access point AP2 may access a network 13 including the Internet, an Internet protocol (IP) network, or any other network. The first access point AP1 may provide, to the first station STA1, the second station STA2, the third station STA3, and the fourth station STA4, access to the network 13 within a first coverage area 11, and the second access point AP2 may also provide, to the third station STA3 and the fourth station STA4, access to the network 13 within a second coverage area 12. According to some embodiments, the first access point AP1 and the second access point AP2 may communicate with at least one of the first station STA1, the second station STA2, the third station STA3, and the fourth station STA4, based on wireless-fidelity (Wi-Fi) or any other WLAN access technology.

An access point may be referred to as a router or a gateway, and a station may be referred to as a mobile station, a subscriber station, a terminal, a mobile terminal, a wireless terminal, a user equipment, or a user. A station may be and/or may include a mobile device, such as, but not limited to, a mobile phone, a laptop computer, or a wearable device, and/or may be and/or may include a stationary device, such as, but not limited to, a desktop computer or a smart television (TV). As used herein, a station may be referred to as a first device and an access point may be referred to as a second device. However, the present disclosure is not limited in this regard. For example, the first device may refer to an access point and the second device may refer to a station.

According to an embodiment, an access point may determine to transmit data in a multi-layer transmission mode. The multi-layer transmission mode may refer to a mode of transmitting data by varying modulation and coding schemes (MCS) for each subchannel when transmitting the data to a single user, which may be analogous to varying MCS for each user when transmitting data to multiple users. The subchannel may be a resource unit (RU) or a multi-RU (MRU). An access point may adjust at least one field of a physical protocol data unit (PPDU) to indicate to a station that a currently transmitted PPDU is based on the multi-layer transmission mode. The adjusting of the at least one field may include defining a new field and/or changing a reserved bit in a pre-defined field.

The wireless communication system 10, according to an embodiment, may perform transmission of data by varying MCS for each subchannel, thereby potentially maximizing merits of a channel selective gain in a frequency domain and/or potentially increasing throughput.

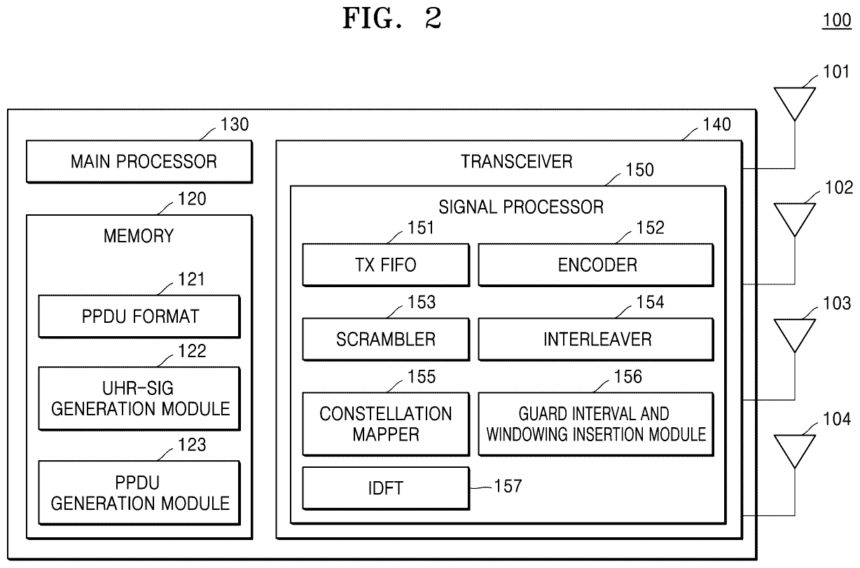

FIG. 2 is a block diagram of an apparatus 100, according to an embodiment.

The apparatus 100 of FIG. 2 may be a second device (e.g., an access point (AP)) that may be and/or may include a transmitting device, or a first device (e.g., a station (STA)) that may be and/or may include a receiving device. For example, the apparatus 100 may include a transceiver capable of performing data communication. That is, the apparatus 100 of FIG. 2 may be any one of the first access point AP1, the second access point AP2, the first station STA1, the second station STA2, the third station STA3, and the fourth station STA4 of FIG. 1. In an embodiment, the apparatus 100 may be applied to a sensor used in a computer, a smartphone, a portable electronic device, a tablet computer, a wearable device, Internet of Things (IoT) device, or the like. Hereinafter, an example in which the apparatus 100 is the second device (e.g., a transmitting device) is described.

The apparatus 100 may include a main processor 130, a memory 120, a transceiver 140, and antenna arrays (e.g., a first antenna array 101, a second antenna array 102, a third antenna array 103, and a fourth antenna array 104). The main processor 130, the memory 120, the transceiver 140, and the first to fourth antenna arrays 101 to 104 may be directly and/or indirectly connected to each other.

In an embodiment, the main processor 130 may control the memory 120 and the transceiver 140. The memory 120 may include a PPDU format 121 and an ultra-high reliability-signal (UHR-SIG) generation module 122. The transceiver 140 may generate a PPDU by using the PPDU format 121 and the UHR-SIG generation module 122 stored in the memory 120. For example, the PPDU may be a UHR PPDU. The transceiver 140 may transmit the generated PPDU to the first device that is an external receiving device, through the first to fourth antenna arrays 101 to 104.

The memory 120 may store the PPDU format 121 including a signal field-related format, according to an embodiment, and the UHR-SIG generation module 122 may be configured to generate a field indicating a multi-layer transmission mode. The memory 120 may store processor-executable instructions for executing a PPDU generation module 123. The processor-executable instructions stored in the memory 120 may be executed by the main processor 130 and/or by a signal processor 150 included in the transceiver 140.

According to an embodiment, the signal processor 150 may generate the PPDU in which current data transmission is a multi-layer transmission mode and indicating MCS for each subchannel, based on the PPDU format 121 and the UHR-SIG generation module 122.

The signal processor 150 may include various modules (e.g., various modules of transmit paths) configured to generate each section of the PPDU or various types of communication transmission unit. Although FIG. 2 illustrates the signal processor 150 as being included in the transceiver 140, the present disclosure is not limited in this regard. For example, the signal processor 150 may be separate from the transceiver 140 and/or may be realized as a separate configuration.

In an embodiment, the signal processor 150 may include a transmit first-in-first-out (TX FIFO) 151, an encoder 152, a scrambler 153, an interleaver 154, a constellation mapper 155 that may be configured to generate a quadrature amplitude modulation (QAM) symbol, an inverse discrete Fourier transformer (IDFT) 157, and a guard interval and windowing insertion module 156 that may be configured to modify a signal through windowing by inserting a guard interval on a frequency so as to reduce spectral interference).

The transceiver 140 may include components well known to one of ordinary skill in the art, as illustrated in the drawing. Also, the components may be executed in a manner well known to one of ordinary skill in the art and may be executed by using hardware, firmware, software logic, or a combination thereof.

According to an embodiment, when the apparatus 100 is the first device (e.g., a receiving device), the transceiver 140 of FIG. 2 may include components in a receiving path.

For example, when the apparatus 100 is the first device, the transceiver 140 may receive the PPDU and determine the MCS of each of a plurality of subchannels and the multi-layer transmission mode, based on the PPDU. That is, the signal processor 150 may extract at least one field of a preamble included in the PPDU and decode the same to identify that the PPDU is based on the multi-layer transmission mode. The signal processor 150 may decode different fields of the preamble included in the PPDU to identify MCS used to encode each of the plurality of subchannels and may decode the PPDU based on the identified MCS. In an embodiment, the decoding may be performed by another component (e.g., the main processor 130) rather than the signal processor 150, however, for ease of description, an embodiment is described with an example in which the signal processor 150 decodes the received PPDU. Although FIG. 2 illustrates an example of the apparatus 100, an embodiment is not limited thereto. In other words, various changes may be made to FIG. 2.

The number and arrangement of components of the apparatus 100 shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Alternatively or additionally, a set of (one or more) components shown in FIG. 2 may be integrated with each other, and/or may be implemented as an integrated circuit, as software, and/or a combination of circuits and software

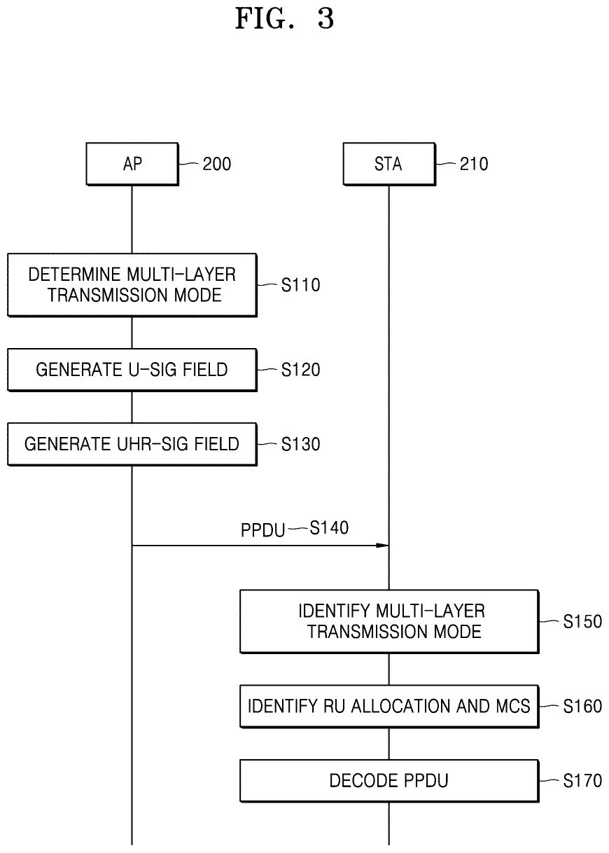

FIG. 3 is a flowchart of an operating method of a wireless communication system, according to an embodiment. The wireless communication system may include an access point 200 and a station 210.

Referring to FIG. 3, in operation S110, the access point 200 may determine a transmission mode for communication with the station 210. For example, the transmission mode may be a multi-layer transmission mode. The multi-layer transmission mode may refer to a multi-layer transmission mode in which different MCSs are applied for each subchannel configuring a channel bandwidth. For example, the access point 200 may determine to transmit data in the multi-layer transmission mode when there is one station in a coverage corresponding to the access point 200 and/or when the data is to be transmitted with high data throughput.

In operation S120, the access point 200 may generate a U-SIG field in response to determining to transmit in the multi-layer transmission mode in operation S110. According to an embodiment, the access point 200 may notify the station 210 that a PPDU is based on the multi-layer transmission mode, by using any one of reserved fields of the U-SIG field. According to another embodiment, the access point 200 may indicate that the PPDU is based on the multi-layer transmission mode, by using at least one of reserved bits according to a combination of U-SIG fields. In an embodiment, the access point 200 and the station 210 may pre-agree whether to use the reserved bit according to the combination of the U-SIG fields or the reserved field of the U-SIG field.

In operation S130, the access point 200 may generate a UHR-SIG field. The UHR-SIG field may include RU allocation information and MCS information.

In operation S140, the access point 200 may transmit the PPDU to the station 210. The access point 200 may generate the PPDU by merging the U-SIG field generated in operation S120, the UHR-SIG field generated in operation S130, and a payload including data and may provide the generated PPDU to the station 210.

In operation S150, the station 210 may identify the multi-layer transmission mode. For example, the station 210 may receive the PPDU from the access point 200 and may identify that the PPDU is transmitted according to the multi-layer transmission mode, based on the U-SIG field of the PPDU. For example, the station 210 may identify the multi-layer transmission mode through at least one of the reserved fields of the U-SIG field or through at least one of the reserved bits of the U-SIG fields.

In operation S160, the station 210 may identify RU allocation and MCS. Since the station 210 has identified that the PPDU has been transmitted according to the multi-layer transmission mode through the U-SIG field in operation S150, the station 210 may identify, through the UHR-SIG field, how RU or MRU is allocated in a frequency domain and which MCS index is allocated to each RU or MRU.

In operation S170, the station 210 may decode the PPDU. For example, the station 210 may decode the data according to an MCS index corresponding to a subchannel to which RU is allocated based on the identified RU-wise MCS index.

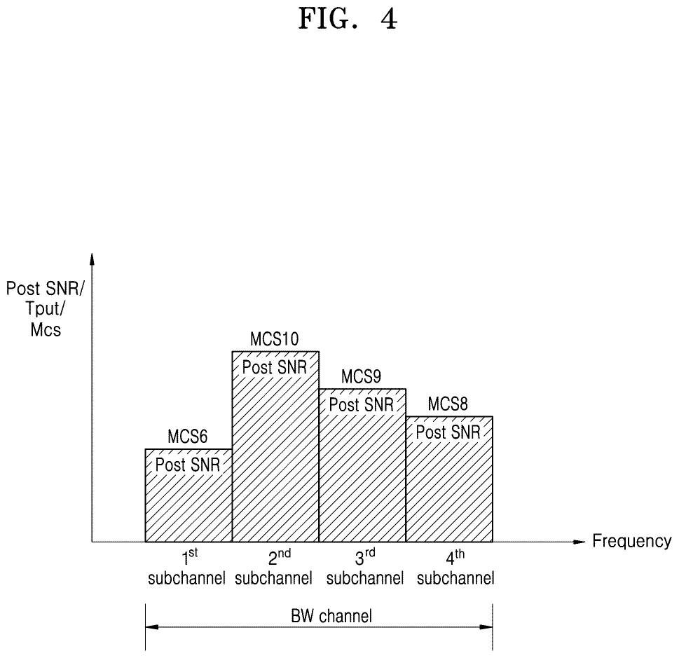

FIG. 4 illustrates an example of frequency-wise MCS, according to an embodiment.

Referring to FIG. 4, a channel over which a PPDU is transmitted may include several subchannels. That is, the bandwidth through which the PPDU is transmitted may be divided into a plurality of subchannels. For example, a unit of the subchannel may be a tone. For example, the bandwidth (BW) of the channel may be 80 MHz, and a first subchannel to a fourth subchannel may each correspond to 242-tone. As another example, the plurality of subchannels may have different channel gains and accordingly, may be based on different MCSs.

MCS may vary for each subchannel, based on performance measurements of that subchannel, such as, but not limited to, a signal-to-noise ratio (SNR), a throughput, or the like. For example, referring to FIG. 4, an SNR of the first subchannel may have a first value, and an MCS index corresponding to the first subchannel may be MCS 6. An SNR of the second subchannel may have a second value that may be greater than the first value, and an MCS index corresponding to the second subchannel may be MCS 10. An SNR of the third subchannel may have a third value that may be less than the second value and may be greater than the first value, and an MCS index corresponding to the third subchannel may be MCS 9. An SNR of the fourth subchannel may have a fourth value that may be less than the third value and may be greater than the first value, and an MCS index corresponding to the fourth subchannel may be MCS 8.

According to the multi-layer transmission mode, in an embodiment, high data throughput may be achieved by setting an MCS level for each subchannel, similarly to setting an MCS level for each user in MU-MIMO.

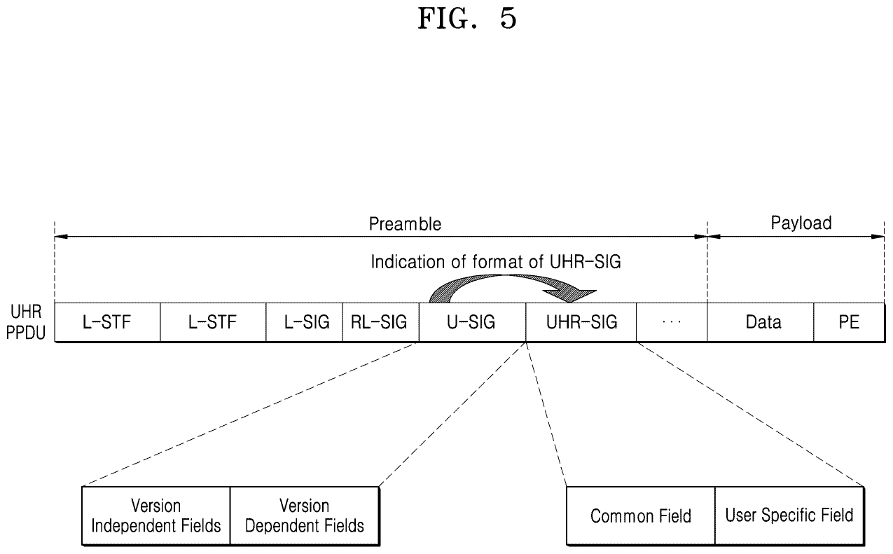

FIG. 5 is a diagram showing a PPDU according to an embodiment. Referring to FIG. 5, a structure of a UHR PPDU is illustrated. Hereinafter, embodiments may be described based on a standard related to UHR, however, the present disclosure may also be applied to other standards related to extremely high throughput (EHT) or the like. In an embodiment, UHR PPDU may also be referred to as EHT PPDU.

Referring to FIG. 5, the UHR PPDU may include a preamble including a plurality of training fields and a plurality of signal fields, and a payload including a data field. The UHR PPDU may include, in the preamble, a legacy-short training field (L-STF), a legacy-long training field (L-LTF), a legacy-signal (L-SIG) field, a repeated legacy-signal (RL-SIG) field, a U-SIG field, a UHR-SIG field, an ultra-high reliability-short training field (UHR-STF), and an ultra-high reliability-long training field (UHR-LTF). Also, the UHR PPDU may include, in the payload, the data field and a packet extension (PE) field. In an embodiment, the L-SIG field, the RL-SIG field, the U-SIG field, and the UHR-SIG field may be referred to as L-SIG, RL-SIG, U-SIG, and UHR-SIG, respectively.

The L-STF may include a short training OFDM symbol and may be used for frame detection, automatic gain control (AGC), diversity detection, and coarse frequency/time synchronization, and the like.

The L-LTF may include a long training OFDM symbol and may be used for fine frequency/time synchronization and channel estimation.

The L-SIG may be used for control information transmission and may include information about a data rate and a data length. According to some embodiments, the L-SIG may be repeated in the RL-SIG.

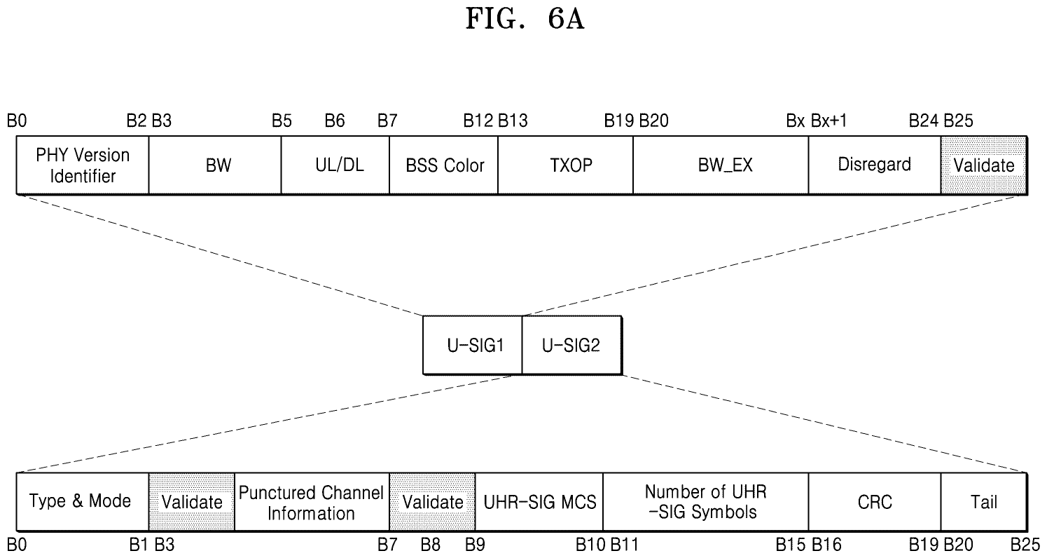

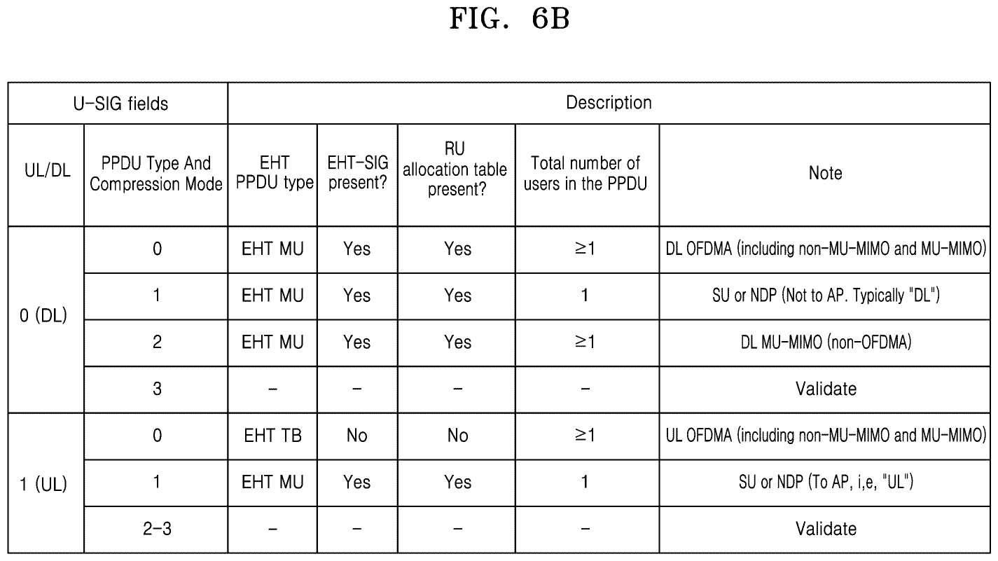

The U-SIG may include control information common in at least one station receiving UHR PPDU. For example, as shown in FIG. 5, the U-SIG field may include version independent fields and version dependent fields. In an embodiment, the version independent fields may correspond to U-SIG1 as described below, and the version dependent fields may correspond to U-SIG2 as described below. According to some embodiments, the U-SIG may further include fields respectively corresponding to cyclic redundancy check (CRC) and a tail, and reserved bits. The version independent fields may have static location and bit definitions in different generations and/or physical versions. The U-SIG may have a static length (e.g., a 52-bit length). According to some embodiments, the U-SIG may be modulated based on a single modulation scheme (e.g., binary phase-shift keying (BPSK)), unlike the UHR-SIG described below. An example of the U-SIG is described with reference to FIG. 6A. A format of the UHR-SIG may vary depending on a transmission mode indicated by the U-SIG.

The UHR-SIG may be composed of UHR-SIG content channels and include pieces of information that may be needed for stations to analyze the UHR PPDU, together with the U-SIG. As shown in FIG. 5, the UHR-SIG may include a common field including common control information, and a user specific field including user-dependent control information. The common field of the UHR-SIG may include U-SIG overflow bits that may include information commonly applied to at least one user and all UHR-SIG content channels. Also, the common field of the UHR-SIG may include resource allocation information for the at least one user to decode, in UHR modulated fields of the PPDU, data through RU or MRU allocated to the at least one user.

The UHR-SIG may have a variable length according to the transmission mode indicated by the U-SIG. For example, the transmission mode indicated by the U-SIG may be any one of a downlink (DL) OFDMA transmission mode, a DL non-OFDMA multi-user (MU) transmission mode, a DL non-OFDMA single user (SU) transmission mode, a UHR sounding null data packet (NDP) mode, and a multi-layer transmission mode.

For example, in the DL OFDMA transmission mode, the common field of the UHR-SIG may include a spatial reuse field, a guard interval (GI) and LTF size field, a UHR-LTF symbol number field, a low density parity check (LDPC) added symbol segment field, a pre-forward error correction (pre-FEC) padding factor field, a packet extension disambiguity field, an RU allocation (RUA) subfield, a CRC field, and a tail field.

As another example, in the non-OFDMA transmission mode (including both MU and SU), the common field of the UHR-SIG may include a spatial reuse field, a GI and LTF size field, a UHR-LTF symbol number field, an LDPC added symbol segment field, a pre-FEC padding factor field, a packet extension disambiguity field, a non-OFDMA user number field, a CRC field, and a tail field.

As another example, in the UHR sounding NDP transmission mode, the common field of the UHR-SIG may include a spatial reuse field, a GI and LTF size field, a UHR-LTF symbol number field, a number of spatial streams (NSS) field, a beamformed field, a disregard field, a CRC field, and a tail field.

According to an embodiment, in the multi-layer transmission mode, the common field of the UHR-SIG may be the same as the common field of the DL OFDMA transmission mode. For example, in the multi-layer transmission mode, the common field of the UHR-SIG may include a spatial reuse field, a GI and LTF size field, a UHR-LTF symbol number field, an LDPC added symbol segment field, a pre-FEC padding factor field, a packet extension disambiguity field, an RUA subfield, a CRC field, and a tail field.

According to some embodiments, the user specific field may include variable information according to the transmission mode. For example, the user specific field for non-MU MIMO may include a STA-ID subfield, an MCS subfield, a number of total space time streams (NSTS) subfield, a beamformed subfield, and a coding subfield, and the user specific field for MU-MIMO may include an STA-ID subfield, an MCS subfield, a coding subfield, and a spatial configuration subfield. According to some embodiments, the UHR-SIG field may be modulated based on one of two or more modulation schemes (e.g., BPSK and quadrature binary phase shift keying (QBPSK)).

FIG. 6A illustrates an example of a U-SIG indicating a multi-layer transmission mode, according to an embodiment.

Referring to FIG. 6A, the U-SIG may be included in a UHR PPDU and precede a UHR-SIG.

According to an embodiment, the U-SIG may be divided into U-SIG1 and U-SIG2. As shown in FIG. 6A, the U-SIG1 may be composed of 26 bits from B0 to B25 and the U-SIG2 may be composed of 26 bits from B0 to B25.

The U-SIG1 is version independent fields and may include a physical version identifier field (3 bits), a bandwidth field (3 bits), an uplink (UL)/DL field (1 bit), a basic service set (BSS) color field (6 bits), a transmit opportunity (TXOP) field (7 bits), a disregard field (5 bits), and a validate field (1 bit).

Also, the U-SIG2 is version dependent fields and may include a PPDU type and compression mode field (2 bits), a validate field (1 bit), a punctured channel information field (5 bits), a validate field (1 bit), a UHR-SIG MCS field (2 bits), an EHT-SIG symbol number field (5 bits), a CRC field (4 bits), and a tail field (6 bits).

According to some embodiments, the multi-layer transmission mode may be indicated by using a reserved field of the U-SIG. For example, an apparatus (e.g., the apparatus 100 of FIG. 2) may indicate that a currently transmitted PPDU is in the multi-layer transmission mode for a single user, by using any one of the validate field of a 26th bit (B25) of the U-SIG1, the validate field of a third bit (B2), and the validate field of a ninth bit (B8) of the U-SIG2. For example, the apparatus 100 may set the last bit of the U-SIG1 to “1” (e.g., logic high) so as to indicate the current transmission of the PPDU is in the multi-layer transmission mode. As another example, the apparatus 100 may set any one of the third bit (B2) or the ninth bit (B8) of the U-SIG2 to “1” (e.g., logic high) so as to indicate the current transmission of the PPDU is in the multi-layer transmission mode.

FIG. 6B illustrates an example of a table indicating the multi-layer transmission mode, according to an embodiment.

Referring to FIG. 6B, the apparatus 100 may indicate a transmission mode of a PPDU based on a combination of U-SIG fields. The transmission mode may be indicated by a combination of a UL/DL field of U-SIG1 and a PPDU type and compression mode field of U-SIG2. For example, when the UL/DL field is “0” (e.g., DL) and the PPDU type and compression mode field is “00” (e.g., zero (0)), the transmission mode of PPDU may be DL OFDMA (e.g., including both non-MU-MIMO and MU-MIMO). When the UL/DL field is “0” (e.g., DL) and the PPDU type and compression mode field is “01” (e.g., one (1)), the transmission mode of PPDU may be single user (SU) or NDP. When the UL/DL field is “0” (e.g., DL) and the PPDU type and compression mode field is “10” (e.g., two (2)), the transmission mode of PPDU may be DL MU-MIMO (e.g., non-OFDMA). According to an embodiment, when the UL/DL field is “0” (e.g., DL) and the PPDU type and compression mode field is “11” (e.g., three (3)), the transmission mode of PPDU may be a multi-layer transmission mode for a single user.

As another example, when the UL/DL field is “1” (e.g., UL) and the PPDU type and compression mode field is “00” (e.g., zero (0)), the transmission mode of PPDU may be UL OFDMA (including both non-MU-MIMO and MU-MIMO). When the UL/DL field is “1” (e.g., UL) and the PPDU type and compression mode field is “01” (e.g., one (1)), the transmission mode of PPDU may be single user (SU) or NDP. According to an embodiment, when the UL/DL field is “1” (e.g., DL) and the PPDU type and compression mode field is “10” (e.g., two (2)) or “11” (e.g., three (3)), the transmission mode of PPDU may be a multi-layer transmission mode for a single user.

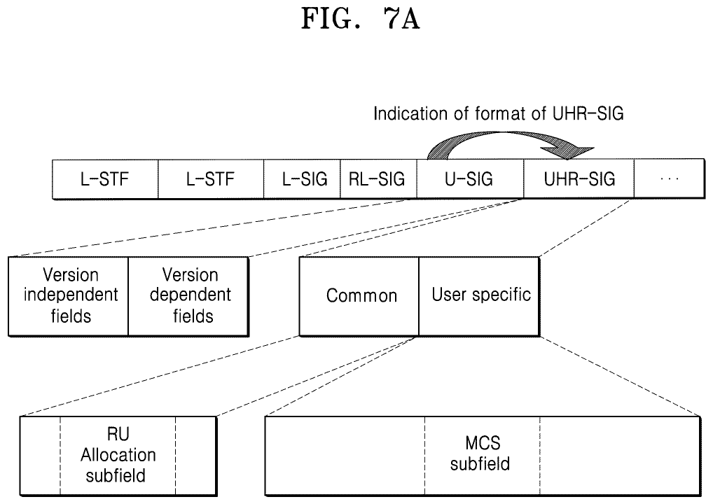

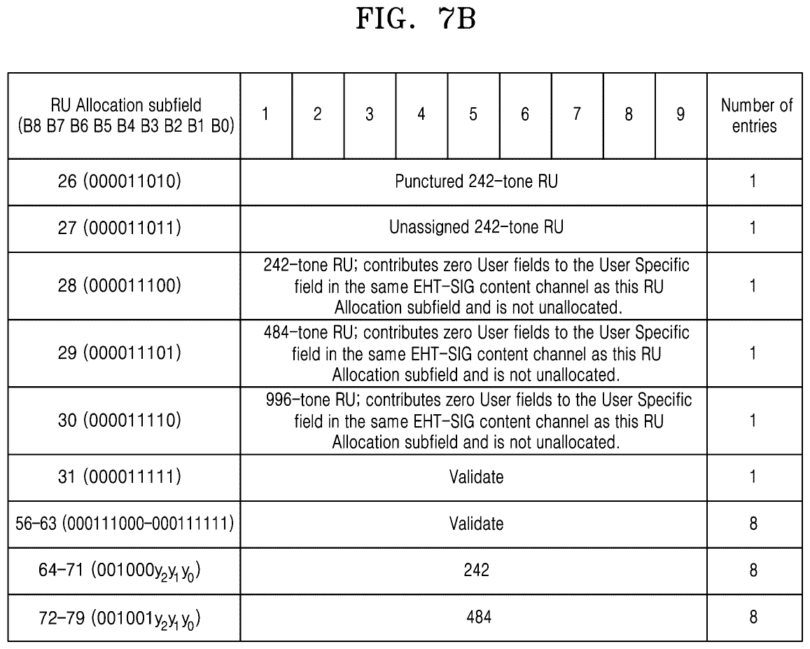

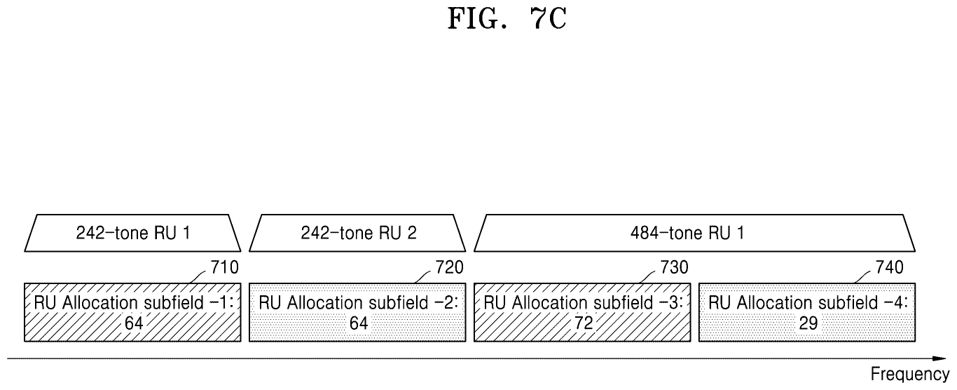

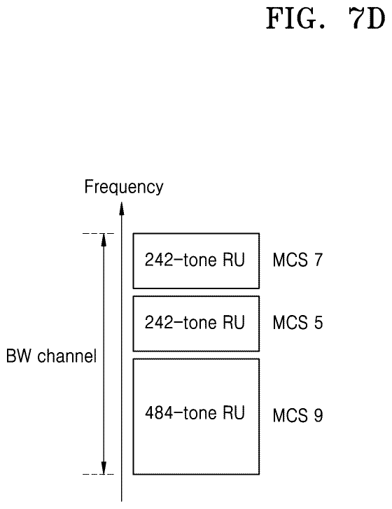

FIG. 7A illustrates an example of UHR-SIG, according to an embodiment. FIG. 7B illustrates an example of an RU allocation subfield table, according to an embodiment. FIG. 7C illustrates an example of RU distribution in a frequency domain, according to an embodiment. FIG. 7D illustrates an example of RU-wise MCS index, according to an embodiment.

Referring to FIG. 7A, the UHR-SIG may include a common field and a user specific field. According to an embodiment, the common field may include an RU allocation subfield. The RU allocation subfield may indicate how an RU or MUR is allocated in a frequency domain. The user specific field may include an MCS subfield.

Referring to FIG. 7B, a value of the RU allocation subfield may be determined according to the RU allocation subfield table. For example, the value of the RU allocation subfield may be 64 for 242-tone RU. The value of the RU allocation subfield may be 72 for 484-tone RU. Referring to the table in FIG. 7B, in a case of at least one user, 242-tone RU may have a value between 64 and 71, and 484-tone MRU may have a value between 72 and 79, and thus, a subfield value of 242-tone RU may be 64 and a subfield value of 484-tone MRU may be 72, according to an embodiment. Also, a subfield value of a 242-tone RU, obtained by excluding a 242-tone RU from a 484-tone MRU having a subfield value of 72, may be 29, as described with reference to FIG. 7C.

Referring to FIG. 7C together, according to an embodiment, the channel bandwidth through which PPDU is transmitted may be 80 MHz. When the bandwidth is 80 MHz, RU allocation may be divided in 242-tone units, and thus, there may be four RU allocation subfields. A first RU 710 may be a 242-tone RU. Thus, according to FIG. 7B, a value of the RU allocation subfield of the first RU 710 may be 64. A second RU 720 may be 242-tone RU, and a value of RU allocation subfield of the second RU 720 may also be 64. A third RU 730 and a fourth RU 740 may each form MRU. As such, the third RU 730 may indicate that 484-tone is a bandwidth of the MRU. A value of the RU allocation subfield of the third RU 730 may be 72 to indicate 484-tone. The fourth RU 740 may include the remaining RU among RU configuring the MRU, and thus may indicate that the user specific field is not used. A value of the RU allocation subfield of the fourth RU 740 may be 29. According to an embodiment, MCS may be differently configured for each RU unit or MRU unit. For example, referring to FIG. 7D together, the first RU 710 may be encoded based on MCS 7, the second RU 720 may be encoded based on MCS 5, and the MRU including the third RU 730 and the fourth RU 740 may be encoded based on MCS 9.

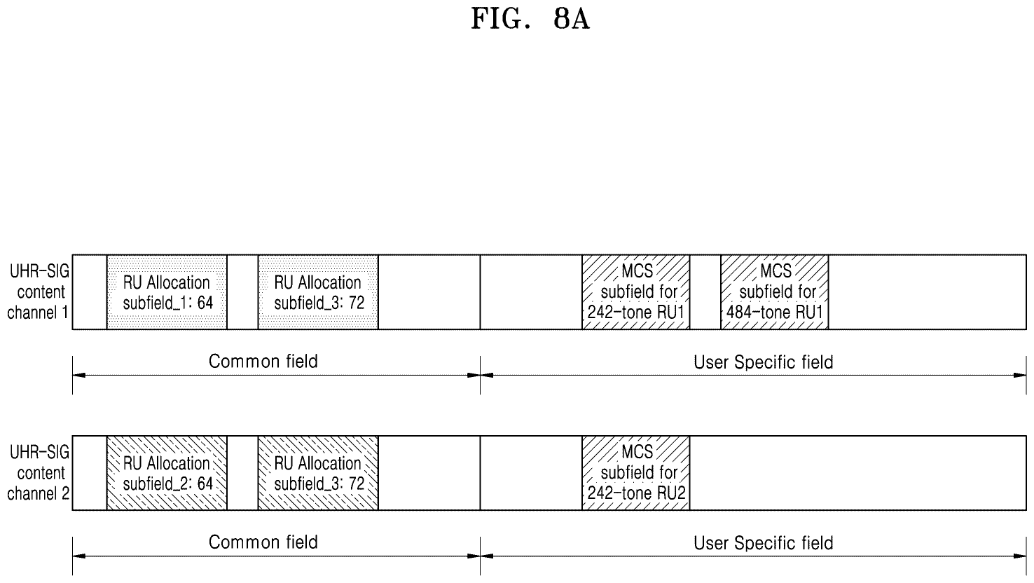

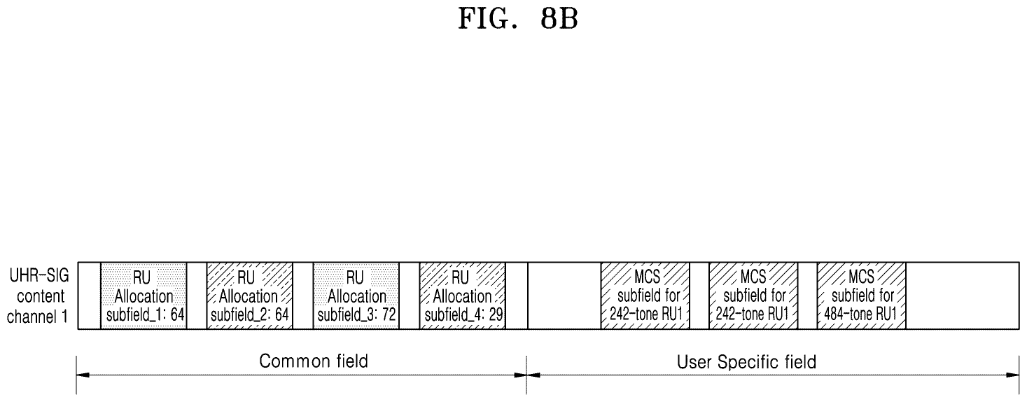

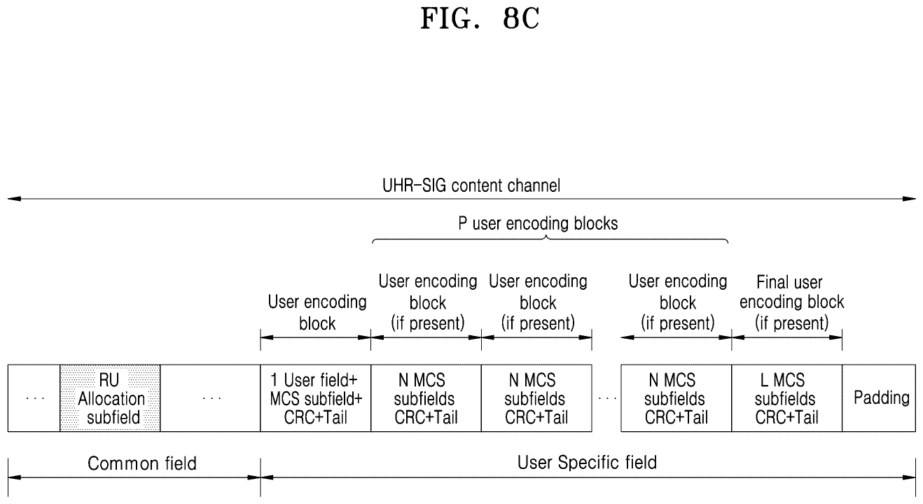

FIG. 8A illustrates an example of a case where there are two UHR-SIG content channels, according to an embodiment. FIG. 8B illustrates an example of a case where there is one UHR-SIG content channel, according to an embodiment. FIG. 8C illustrates an example of an encoding unit of a UHR-SIG content channel, according to an embodiment.

Referring to FIG. 8A, UHR-SIG may include two content channels. For example, when the UHR-SIG includes two content channels, content channel 1 may indicate, through an RU allocation subfield, allocation of RU or MRU for an odd-th 20 MHz subchannel within a channel bandwidth. Content channel 2 may indicate, through the RU allocation subfield, allocation of RU or MRU for an even-th 20 MHz subchannel within the channel bandwidth. For example, a common field of the content channel 1 of UHR-SIG may include values of RU allocation subfields of a first RU (e.g., the first RU 710 of FIG. 7C) and a third RU (e.g., the third RU 730 of FIG. 7C), which correspond to odd-th numbers. A common field of the content channel 2 of UHR-SIG may include values of RU allocation subfields of a second RU (e.g., the second RU 720 of FIG. 7C) and a fourth RU (e.g., the fourth RU 740 of FIG. 7C), which correspond to even-th numbers.

A user specific field of each content channel may include an MCS subfield indicating an MCS for an RU or MRU included in the common field. For example, the user specific field of the content channel 1 of UHR-SIG may include a first MCS subfield and a third MCS subfield respectively corresponding to the first RU and the third RU. Referring to FIG. 7D together, the first MCS subfield may include a value indicating which MCS index is used to encode the first RU. The value of the RU allocation subfield of the third RU is 72, and thus, the third MCS subfield may indicate which MCS index is used to encode an MRU including the third RU.

The user specific field of the content channel 2 of UHR-SIG may include only a second MCS subfield corresponding to the second RU. Referring to FIG. 7D together, the second MCS subfield may include a value indicating which MCS index is used to encode the second RU. For example, the value of the RU allocation subfield of the fourth RU may be 28. The fourth RU may configure the MRU together with the third RU, and the MCS index of the MRU may have been already indicated by the third MCS subfield of the content channel 1, and thus, there may be no fourth MCS subfield.

Referring to FIG. 8B, the UHR-SIG may include one content channel. For example, when the UHR-SIG includes one content channel, the content channel may indicate allocation of RU or MRU for all 20 MHz subchannels within the channel bandwidth. For example, a common field of the content channel of UHR-SIG may include values of RU allocation subfields of the first RU (e.g., the first RU 710 of FIG. 7C) to the fourth RU (e.g., the fourth RU 740 of FIG. 7C). Referring to FIG. 7C together, the common field of the content channel may include a first RU allocation subfield having a value “64”, a second RU allocation subfield having a value “64”, a third RU allocation subfield having a value “72”, and a fourth RU allocation subfield having a value “29”.

A user specific field of the content channel of FIG. 8B may include an MCS subfield indicating an MCS for all RUs or MRUs included in the common field. For example, the user specific field of the content channel may include the first MCS subfield to the third MCS subfield respectively corresponding to the first RU to the third RU. Referring to FIG. 7D together, the value of the RU allocation subfield of the fourth RU may be 28. The fourth RU may configure the MRU together with the third RU, and the MCS index of the MRU may have been already indicated by the third MCS subfield, and thus, there may be no fourth MCS subfield.

Referring to FIG. 8C, when the common field includes K RU allocation subfields, the user specific field may include total K MCS subfields, where K is a positive integer greater than zero (0). For example, an apparatus (e.g., the apparatus 100 of FIG. 2) may perform encoding by inserting CRC and a tail bit every specific bit interval. For example, an initial encoding block may include a user field and M MCS subfields, where M is a positive integer greater than zero (0). Then, P encoding blocks may identically include N MCS subfields, where P and N are positive integers greater than zero (0). The last encoding block may include L MCS subfields, where L is a positive integer greater than zero (0).

According to some embodiments, one MCS subfield may be included in the user field of the initial encoding block. In this case, total K MCS indexes indicated through the user specific field may be represented as an equation similar to Equation 1.

K=1+M+(P×N)+L [Equation 1]

Referring to Equation 1, the total K MCS indexes of RUs or MRUs may be equal to the sum of one MCS subfield in the user field, the M MCS subfields included in the initial encoding block, the N MCS subfields included for each of the P encoding blocks (e.g., P×N), and the L MCS subfields included in the last encoding block. In an embodiment, N may be greater than or equal to L (e.g., N≥L) and may be greater than or equal to M (e.g., N≥M).

According to some embodiments, the user field of the initial encoding block may not include an MCS subfield. In this case, the total K MCS indexes indicated through the user specific field may be represented as an equation similar to Equation 2.

K=M+(P×N)+L [Equation 2]

Referring to Equation 2, the total K MCS indexes of RUs or MRUs may be equal to the sum of the M MCS subfields included in the initial encoding block, the N MCS subfields included for each of the P encoding blocks (e.g., P×N), and the L MCS subfields included in the last encoding block. In an embodiment, N may be greater than or equal to L (e.g., N≥L) and N may be greater than or equal to M (e.g., N≥M).

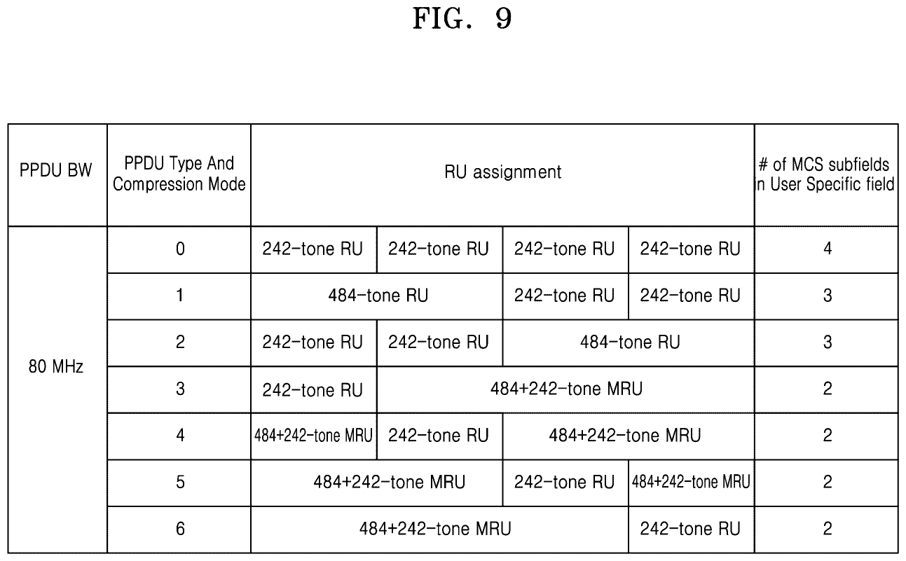

FIG. 9 illustrates an example of an RU assignment subfield, according to an embodiment.

Referring to FIG. 9, an RU assignment table may include values indicating whether a channel bandwidth is assigned in RU or MRU of a pre-determined pattern. That is, in the embodiments described above with reference to FIGS. 7A to 8C, the common field of the content channel of UHR-SIG may include the values of RU allocation subfields of all RUs according to the table of RU allocation subfield. However, when a bandwidth is increased (e.g., 320 MHz or 640 MHz), the number of RUs or MRUs included in the bandwidth may be exponentially increased, and thus, the length of the content channel of UHR-SIG may be increased. Accordingly, the length of the common field may be decreased by using the RU assignment table.

Referring to FIG. 9, when the bandwidth is 80 MHz, the RU assignment table may include values of indexes from 0 to 6. When the index of the RU assignment table is zero (0), the RU assignment subfield may indicate that an MRU does not exist in the bandwidth and that a first RU (e.g., the first RU 710 of FIG. 7C) to a fourth RU (e.g., the fourth RU 740 of FIG. 7C) are encoded based on different MCSs. When the index of the RU assignment table is zero (0), the total number of MCS subfields included in a user specific field may be four (4).

When the index of the RU assignment table is one (1), the bandwidth may include the third RU, the fourth RU, and a 484-tone MRU including the first RU and the second RU. That is, the MRU including the first RU and the second RU, the third RU, and the fourth RU may be encoded based on different MCSs. In an embodiment, the first RU and the second RU may be encoded based on a same MCS. When the index of the RU assignment table is one (1)), the total number of MCS subfields included in the user specific field may be three (3).

When the index of the RU assignment table is two (2), the bandwidth may include the first RU, the second RU, and a 484-tone MRU including the third RU and the fourth RU. That is, the first RU, the second RU, and the MRU including the third RU and the fourth RU may be encoded based on different MCSs. In an embodiment, the third RU and the fourth RU may be encoded based on a same MCS. When the index of the RU assignment table is two (2), the total number of MCS subfields included in the user specific field may be three (3).

When the index of the RU assignment table is three (3), the bandwidth may include the first RU, the second RU, and the 484-tone MRU including the third RU and the fourth RU. However, unlike a case where the index of the RU assignment table is two (2), the MRU including the third RU and the fourth RU, and the second RU may be encoded based on a same MCS. That is, the second RU to the fourth RU may be encoded based on a same MCS, and only the first RU may be encoded based on a different MCS. When the index of the RU assignment table is three (3), the total number of MCS subfields included in the user specific field may be two (2).

When the index of the RU assignment table is four (4), the bandwidth may include the first RU, the second RU, and the 484-tone MRU including the third RU and the fourth RU. However, unlike a case where the index of the RU assignment table is two (2), the MRU including the third RU and the fourth RU, and the first RU may be encoded based on a same MCS. That is, the first RU, the third RU, and the fourth RU may be encoded based on a same MCS, and only the second RU may be encoded based on a different MCS. When the index of the RU assignment table is four (4), the total number of MCS subfields included in the user specific field may be two (2).

When the index of the RU assignment table is five (5), the bandwidth may include the 484-tone MRU including the first RU and the second RU, the third RU, and the fourth RU. However, unlike a case where the index of the RU assignment table is one (1), the MRU including the first RU and the second RU, and the fourth RU may be encoded based on a same MCS. That is, the first RU, the second RU, and the fourth RU may be encoded based on a same MCS, and only the third RU may be encoded based on a different MCS. When the index of the RU assignment table is five (5), the total number of MCS subfields included in the user specific field may be two (2).

When the index of the RU assignment table is six (6), the bandwidth may include the 484-tone MRU including the first RU and the second RU, the third RU, and the fourth RU. However, unlike a case where the index of the RU assignment table is one (1), the MRU including the first RU and the second RU, and the third RU may be encoded based on a same MCS. That is, the first RU to the third RU may be encoded based on a same MCS, and only the fourth RU may be encoded based on a different MCS. When the index of the RU assignment table is six (6), the total number of MCS subfields included in the user specific field may be two (2).

Although FIG. 9 depicts an RU assignment table when the bandwidth is 80 MHZ, the present disclosure is not limited thereto. According to some embodiments, it is to be apparent that an RU assignment table corresponding to a wider bandwidth (e.g., 320 MHz or 640 MHz) may be used.

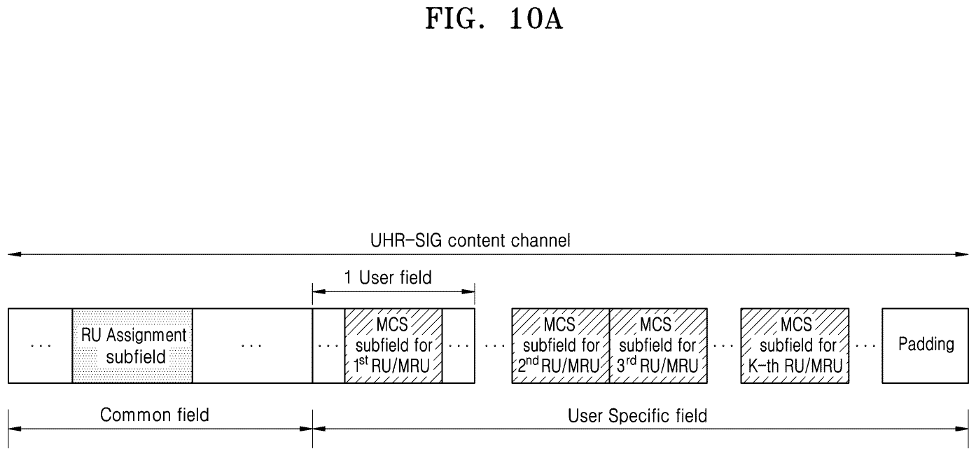

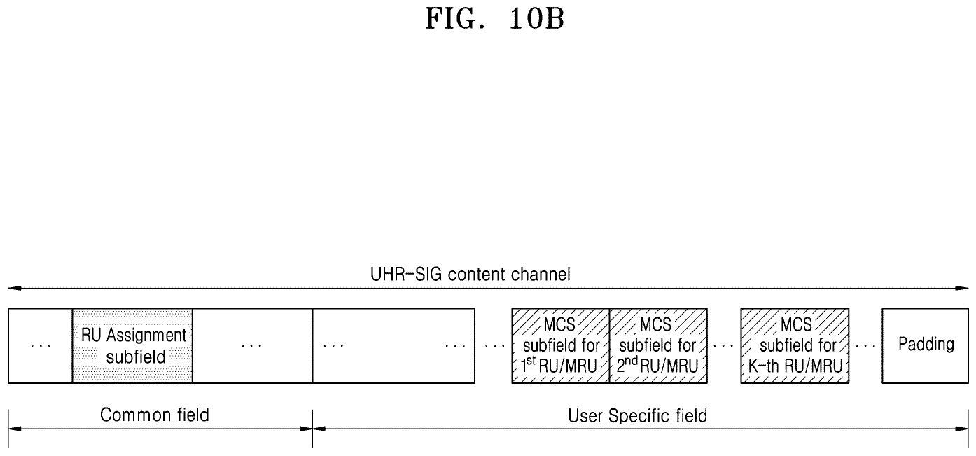

FIG. 10A illustrates an example of a UHR-SIG content channel including an RU assignment subfield, according to an embodiment. FIG. 10B illustrates another example of a UHR-SIG content channel including an RU assignment subfield, according to an embodiment.

Referring to FIG. 10A, UHR-SIG may include a content channel. A common field of the content channel may include an RU assignment subfield. The RU assignment subfield may include a value of an index of the RU assignment table of FIG. 9. Referring to FIG. 8B together, the common field of FIG. 8A may include four RU allocation subfields when the bandwidth is 80 MHz, whereas the common field of FIG. 10A may include only one RU assignment subfield to indicate RU or MRU assignment. Also, the number of MCS subfields included in a user specific field may be identified by identifying only the RU assignment subfield. According to some embodiments, an initial encoding block of a user specific field of FIG. 10A may include one MCS subfield. An initial encoding block of a user specific field of FIG. 10B may not include an MCS subfield.

The UHR-SIG content channel of FIG. 10A may include and/or may be similar in many respects to the UHR-SIG content channel described above with reference to FIG. 8B, and may include additional features not mentioned above. Consequently, repeated descriptions of the UHR-SIG content channel of FIG. 10A described above with reference to FIG. 8B may be omitted for the sake of brevity.

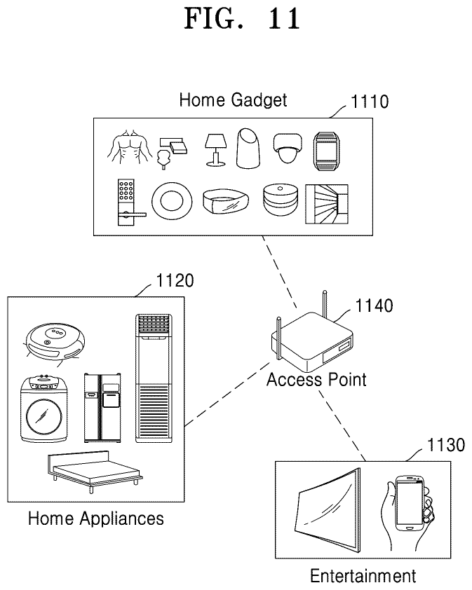

FIG. 11 is a diagram of examples of an apparatus for wireless communication, according to an embodiment.

Referring to FIG. 11, an IoT network system including home gadgets 1110, home appliances 1120, entertainment devices 1130, and an access point 1140 is illustrated.

According to some embodiments, in an apparatus for wireless communication of FIG. 11 (e.g., the home gadgets 1110, the home appliances 1120, and the entertainment devices 1130), as described above with reference to FIGS. 1 to 10B, a PPDU including U-SIG indicating a multi-layer transmission mode in which MCSs are different for each subchannel, and UHR-SIG indicating an MCS for each subchannel may be transmitted, and accordingly, information of RU-wise MCS through which the PPDU is transmitted may be accurately transmitted. Accordingly, in a WLAN system, communication of high throughput may be effectively supported by varying an MCS for each subchannel.

According to an embodiment, a wireless communication system may transmit data based on an MCS different for each subchannel, thereby maximizing merits of a channel selective gain in a frequency domain and increasing throughput.

Hereinabove, embodiments have been described in the drawings and specification. In the present specification, although the embodiments have been described by using specific terms, the terms are used only for descriptive purposes and are not intended to limit the meanings or scope of the present disclosure described in the claims. Therefore, it is to be understood by one of ordinary skill in the art that other modifications and equivalents may be made therein. Accordingly, the scope of the present disclosure will be defined by the appended claims.

1. A wireless communication method of an apparatus, the wireless communication method comprising:
determining a multi-layer transmission mode of transmitting data to a single user, based on modulation and coding schemes (MCSs) different for each of a plurality of subchannels configuring a bandwidth channel;
generating a first field indicating that the wireless communication method is based on the multi-layer transmission mode;
generating a second field indicating a distribution of the plurality of subchannels and the MCSs;
generating a physical protocol data unit (PPDU) comprising the first field and the second field; and
transmitting the PPDU to an external device.

2. The wireless communication method of claim 1, wherein the generating the first field comprises:
changing at least one value of reserved fields in a universal signal (U-SIG) field.

3. The wireless communication method of claim 1, wherein the generating the second field comprises:
generating a common field comprising resource unit (RU) allocation information indicating the distribution of the plurality of subchannels; and
generating a user specific field comprising an MCS subfield indicating an MCS index of each of the plurality of subchannels, and
wherein the distribution of the plurality of subchannels comprises at least one RU and a multi-RU (MRU).

4. The wireless communication method of claim 1, wherein the generating the first field comprises:
changing at least one of reserved bits corresponding to a combination of a uplink/downlink (UL/DL) field and a PPDU type and compression mode field.

5. The wireless communication method of claim 1, wherein the generating the second field comprises:
generating a common field comprising a resource unit (RU) assignment subfield indicating an index obtained by classifying the distribution of the plurality of subchannels according to a pre-determined pattern; and
generating a user specific field comprising an MCS subfield indicating an MCS index of each of the plurality of subchannels.

6-10. (canceled)

11. A wireless communication method of an apparatus, the wireless communication method comprising:
determining, based on a first modulation and coding scheme (MCS) of a first subchannel from among a plurality of subchannels configuring a bandwidth channel and based on a second MCS of a second subchannel of the plurality of subchannels, a multi-layer transmission mode of transmitting data to a single user, the second MCS being different from the first MCS, the second subchannel being different from the first subchannel;
generating a first field indicating that the wireless communication method is based on the multi-layer transmission mode;
generating a second field indicating first resource unit (RU) information of the first subchannel, second RU information of the second subchannel, the first MCS, and the second MCS;
generating a physical protocol data unit (PPDU) comprising the first field and the second field; and
transmitting the PPDU to an external device.

12. The wireless communication method of claim 11, wherein the generating the first field comprises:
changing at least one value of a last bit of a version independent field of a universal signal (U-SIG) field, and
changing a third or ninth bit of a version dependent field of the U-SIG field.

13. The wireless communication method of claim 11, wherein the generating the second field comprises:
generating a common field comprising a first RU allocation subfield indicating a first size of the first subchannel, and a second RU allocation subfield indicating a second size of the second subchannel; and
generating a user specific field comprising a first MCS subfield indicating the first MCS corresponding to the first subchannel, and a second MCS subfield indicating the second MCS corresponding to the second subchannel.

14. The wireless communication method of claim 11, wherein the generating of the first field comprises:
configuring a PPDU type and compression mode field as “11”, based on a uplink/downlink (UL/DL) field being a logic high; and
configuring the PPDU type and compression mode field as “10” or “11”, based on the UL/DL field being a logic low.

15. The wireless communication method of claim 11, wherein the generating the second field comprises:
generating a common field comprising an RU assignment subfield comprising index values of patterns where the first subchannel and the second subchannel are configurable; and
generating a user specific field comprising a first MCS subfield indicating the first MCS corresponding to the first subchannel, and a second MCS subfield indicating the second MCS corresponding to the second subchannel.

16. A wireless communication method of an apparatus, the wireless communication method comprising:
receiving a physical protocol data unit (PPDU) from an external device;
identifying that the PPDU is transmitted according to a multi-layer transmission mode, based on a first field in the PPDU, wherein the multi-layer transmission mode corresponds to a mode of transmitting data to a single user, based on a first modulation and coding scheme (MCS) of a first subchannel from among a plurality of subchannels configuring a bandwidth channel and based on a second MCS of a second subchannel of the plurality of subchannels, the second MCS being different from the first MCS, the second subchannel being different from the first subchannel;
identifying, based on a second field in the PPDU, a distribution of the first subchannel and the second subchannel in a bandwidth, the first MCS, and the second MCS; and
decoding the PPDU, based on the distribution of the first subchannel and the second subchannel, the first MCS, and the second MCS.

17. The wireless communication method of claim 16, wherein the identifying that the PPDU is transmitted according to the multi-layer transmission mode comprises:
identifying that at least one value of a last bit of a version independent field of a universal signal (U-SIG) field, and a third bit or a ninth bit of a version dependent field of the U-SIG field is changed.

18. The wireless communication method of claim 16, wherein the second field comprises:
a common field comprising a first resource unit (RU) allocation subfield indicating a first size of the first subchannel and a second RU allocation subfield indicating a second size of the second subchannel; and
a user specific field comprising a first MCS subfield indicating the first MCS corresponding to the first subchannel and a second MCS subfield indicating the second MCS corresponding to the second subchannel.

19. The wireless communication method of claim 16, wherein the identifying that the PPDU is transmitted according to the multi-layer transmission mode comprises:
identifying whether a PPDU type and compression mode field is configured as “11”, based on a uplink/downlink (UL/DL) field being a logic high; and
identifying whether the PPDU type and compression mode field is configured as “10” or “11”, based on the UL/DL field being a logic low.

20. The wireless communication method of claim 16, wherein the second field comprises:
a common field comprising a resource unit (RU) assignment subfield comprising index values of patterns where the first subchannel and the second subchannel are configurable; and
a user specific field comprising a first MCS subfield indicating the first MCS corresponding to the first subchannel and a second MCS subfield indicating the second MCS corresponding to the second subchannel.
